(19) United States
(12) Patent Application Publication
(10) Pub. No.: US 2003/0172578 A1
(43) Pub. Date: Sep. 18, 2003

(54) Fishing lures

(76) Inventor: Stephen C. Harner, Bishop, CA (US)

Correspondence Address: Eric K. Satermo, Registered Patent Agent, P.O. Box 19099, Irvine, CA, 92623-9099, US

(21) Appl. No.: 10/263,388

(22) Filed: Oct. 2, 2002

Related U.S. Application Data
(63) Continuation-in-part of application No. 09/784,728, filed on Feb. 14, 2001, now abandoned.
(60) Provisional application No. 60/182,865, filed on Feb. 16, 2000.
(60) Provisional application No. 60/327,017, filed on Oct. 3, 2001.

(51) Int. Cl. A01K 85/00

(52) U.S. Cl. 43/42.22

(57) ABSTRACT

A fishing lure includes a body with a head, a central portion, a tail, a dorsal side, and a ventral side. The body has a centerline defined from the head to the tail and between the dorsal and ventral sides. The body has a center of gravity located between the centerline and the dorsal side. The fishing lure may include a harness for attaching the body to a line with a hook. The body may include a channel formed therethrough from the head to the central portion at an angle in the range of about 30 degrees to about 60 degrees. The channel may be configured for receiving a harness for attaching the body to a line with a hook. The harness may have a through hole extending between the ends for slidably receiving line.

### CROSS REFERENCE TO RELATED APPLICATIONS

The present application is a continuation-in-part application of U.S. patent application Ser. No. 09/784,728 filed Feb. 14, 2001, which application claims priority on U.S. Provisional Application for Patent Serial No. 60/182,865, and claims priority on U.S. Provisional Application for Patent Serial No. 60/327,017 filed Oct. 3, 2001. The specification and drawings of each of these applications are incorporated herein by reference.

### BACKGROUND OF THE INVENTION

The present invention relates to fishing lures.

The art of fishing lures is constantly evolving. Designers, artists, and manufacturers are striving to develop more and more realistic lures to improve the fishing experience. There remains an on-going need in the art for fishing lures with enhanced hydrodynamic properties.

### SUMMARY OF THE INVENTION

According to one aspect of the invention, a fishing lure includes a body with a head, a central portion, a tail, a dorsal side, and a ventral side. The body has a centerline defined from the head to the tail and between the dorsal and ventral sides. The body has a center of gravity located between the centerline and the dorsal side. The fishing lure may include a harness for attaching the body to a line with a hook.

According to another aspect of the invention, a fishing lure includes a body with a head, a central portion, a tail, a dorsal side, and a ventral side. The body may include a channel formed therethrough from the head to the central portion at an angle in the range of about 30 degrees to about 60 degrees. The channel may be configured for receiving a harness for attaching the body to a line with a hook.

According to another aspect of the invention, a fishing lure includes a body with a head, a central portion, a tail, a dorsal side, and a ventral side. The body may include a channel formed therethrough from the head to the central portion at an angle in the range of about 30 degrees to about 60 degrees. The lure may also include a harness received within the channel and having a line end, a hook end, and a through hole extending between the ends for slidably receiving line. The line end may be positioned at or near an opening of the channel in the head of the body, and the hook end may be positioned at or near an opening of the channel in the ventral side of the central portion of the body.

### BRIEF DESCRIPTION OF THE SEVERAL VIEWS OF THE DRAWINGS

FIG. 1 is a side view of a body of a fishing lure;

FIG. 2 is cross-sectional view taken along line 2-2 of FIG. 1;

FIG. 3 is a ventral view of a body of a fishing lure;

FIG. 4 is a side view of a fishing lure;

FIG. 5 illustrates a harness;

FIG. 6 is cross-sectional view taken along line 6-6 of FIG. 5;

FIG. 7 is a side view of a fishing lure;

FIG. 8 illustrates a two-armed harness;

FIG. 9 is a perspective view of a harness;

FIG. 10 illustrates another harness;

FIG. 11 illustrates a frame of a harness;

FIG. 12 illustrate still another harness;

FIG. 13 is a side view of a body of a fishing lure;

FIG. 14 is a ventral view of the body of FIG. 13; and

FIG. 15 is a side view of another fishing lure.

### DETAILED DESCRIPTION OF THE INVENTION

A fishing lure 100 according to a number of embodiments is illustrated in FIG. 1. Exemplary fishing lure 100 may include a body 102 having a head 104, a central portion 106, a tail 108, a dorsal side 110, and a ventral side 112. The body 102 has a centerline C defined from the head 104 to the tail 108 and between the dorsal and ventral sides 110 and 112. For the purposes of this description, the centerline C may be defined as a line equidistant between the dorsal and ventral sides 110 and 112.

According to a number of embodiments, the body 102 having a center of gravity G located between the centerline C and the dorsal side 110. More specifically, with additional reference to FIG. 2, the body 102 may be configured so that a greater portion of the mass is located toward the dorsal side 110 rather than the ventral side 112. The resulting hydrodynamic motion of the body 102 through water is more realistic than otherwise and mimics the movement of a real fish.

In a number of embodiments, the body 102 may be made from thermal plastic, which is buoyant. Accordingly, with a center of mass G located above the centerline C, the body 102 has greater buoyancy above the centerline C than below.

As can be seen in FIG. 2, in a number of embodiments the cross-sectional profile of the body 102, particularly at the central portion 106, may have a width defined between a right side 114 and a left side 116 of the body that is greater above the center line C than below the center line C. In other embodiments, the cross-sectional profile may be described as having an inverted trapezoidal shape as illustrated in FIG. 2.

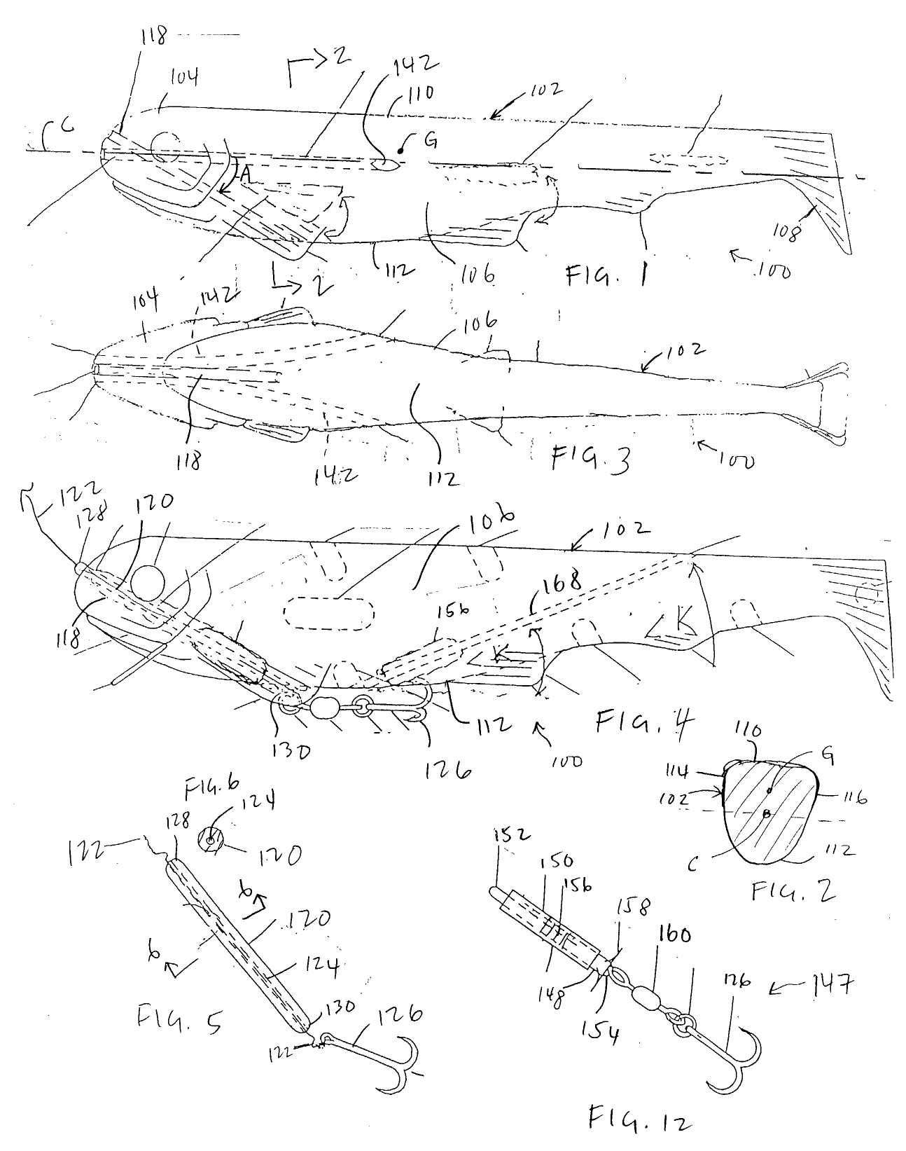

According to a number of embodiments, the body 102 may include a channel 118 for receiving a harness (which will be described below). More specifically, with additional reference to FIG. 3, the channel 118 may extend between the head 104 and the ventral side 112 of the body 102.

As shown in FIG. 1, the channel 118 extends through the body 102 at an angle A with respect to the centerline C. According to some of the embodiments, the angle A may range from about 30 degrees to about 60 degrees. According to other embodiments, the angle A may be about 45 degrees.

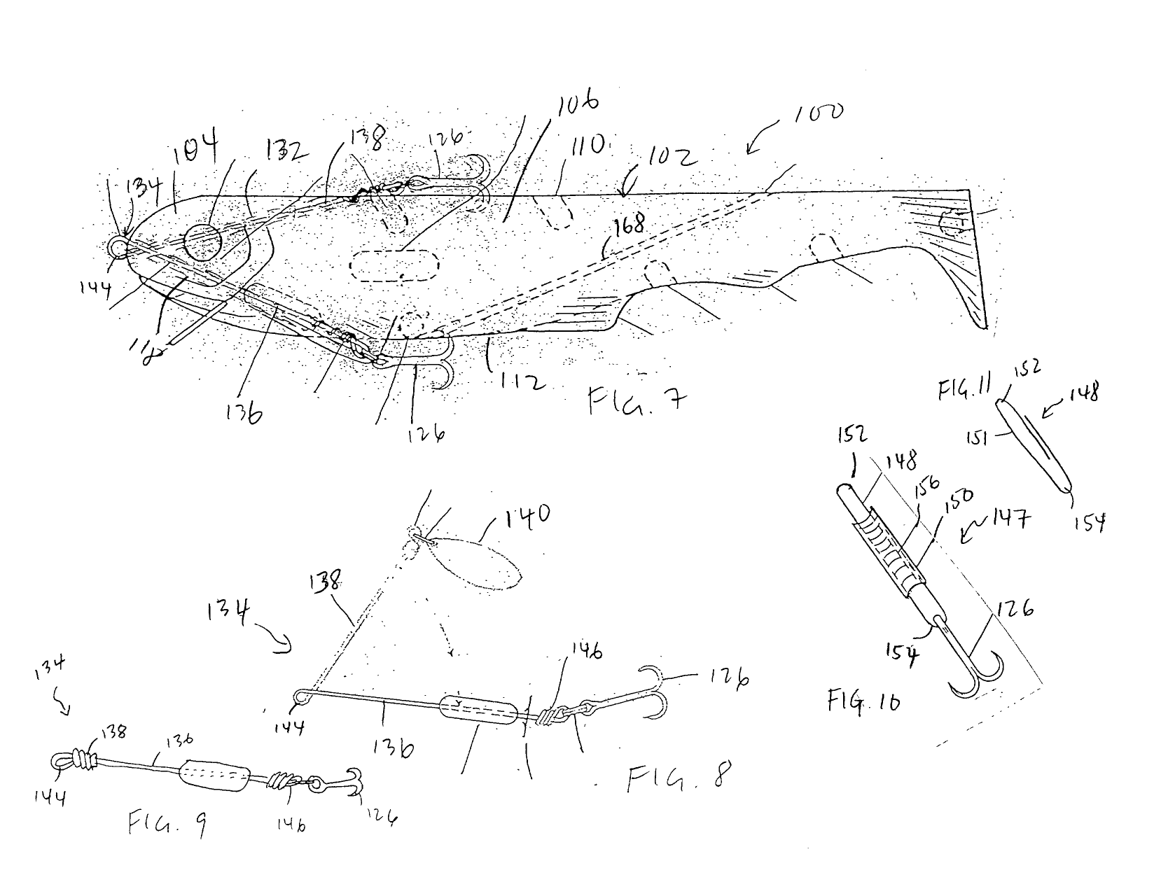

With additional reference to FIG. 4, in a number of embodiments the fishing lure 100 may include a harness 120 received within the channel 118. The harness 120 is a device for attaching the lure 100 to fishing line 122. For example, as shown in FIGS. 5 and 6, the harness 120 may include a through hole 124 through which line 122 is receivable. In a number of embodiments, the line 122 is slidably received in the through hole 124 so that the body 102 is moveable with respect to the line 122.

In some of the embodiments, the harness 120 is substantially tubular and elongate as shown in FIGS. 5 and 6. In other embodiments, the harness 120 is made from a heavy material such as lead so that the harness 120 provides weight to the lure 100.

As shown in FIGS. 4 and 5, the lure 100 may also include a hook 126 attached to an end of the line 122 such that the hook 126 is positioned at or near the ventral side 112 of the central portion 106 of the body 102. In embodiments where the harness 120 is slidably received on the line 122, when a fish (not shown) is attached to the hook 126, the body 102 is able to slide up the line 122 and away from the hook 126 and fish.

As shown in FIG. 4, the harness 120 may have a line end 128 positioned at or near an opening of the channel 118 in the head 104 of the body 102 and a hook end 130 positioned at or near an opening of the channel 118 in the ventral side 112 of the central portion 106 of the body 102. In a number of embodiments, the line and hook ends 128 and 130 of the harness 120 may be rounded as shown in FIG. 5.

With reference to FIG. 7, in a number of embodiments the body 102 may include a second channel 132 extending from the head 104 to the dorsal side 110 of the central portion 106. Accordingly, the lure 100 may include a harness 134 as shown in FIG. 8. In a number of embodiments, the harness 134 may include first and second arms 136 and 138 respectively received within the channels 118 and 132. Accordingly, a hook 126 may be attached to the ends of the arms 136 and 138 as shown in FIG. 7, or, alternatively, a spinner 140 may be attached to either one of the arms.

Referencing FIGS. 1 and 2, in a number of embodiments the body 102 may include one or more pathways 142 through which water is passable. The pathway(s) 142 may extend from the head 104 to one of the sides 114 or 116. The pathways 142 enhance the hydrodynamics and realism of the lure 100 in the water.

Referring to FIG. 8, in some embodiments, arm 138 may be cut off and wrapped about arm 138, thereby yielding a single-arm harness 134 shown in FIG. 9. In either embodiment, the harness 134 may include an eyelet 144 for attaching to line and a hook end 146 for attaching to a hook 126.

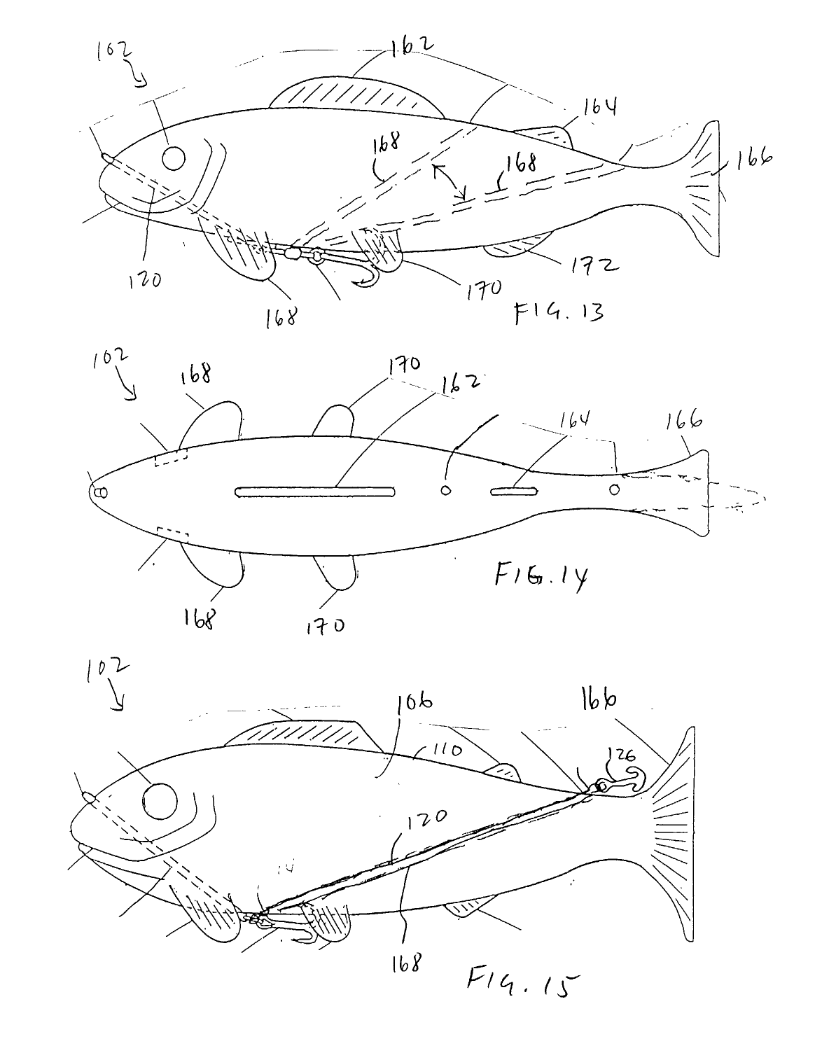

An alternative embodiment of a harness 147 is illustrated in FIG. 10 in which the harness may include a frame 148 and a jacket 150. In a number of embodiments such as shown in FIG. 11, the frame 148 may include a wire 151 that is bent to form a line end 152 for attaching to line and a hook end 154 for attaching to a hook 126. The frame 148 may then be secured by disposing the jacket 150 thereabout. The harness 147 may then be inserted into a channel 118 of a body 102.

According to a number of embodiments, the jacket 150 may be made from a material that provides weight, such as lead. Accordingly, when positioned within a channel 118, the weight of the jacket 150 overcomes the buoyancy of the body 102 and causes the lure 100 to sink.

In other embodiments, the jacket 150 may include surface discontinuities 156 to aid in retaining the harness 147 within a channel 118. Examples of fabrication may include casting the jacket 150 about the frame 148, wrapping the jacket 150 about the frame 148, and inserting the jacket 150 over the frame 148. As shown in FIG. 4, the channel 118 may include a cavity 156 for receiving the jacket 150 when the harness 147 is inserted.

In alternative embodiments of the harness 147 such as shown in FIG. 12, a retainer 158 may be disposed about the frame 148. When received within a channel 118, the retainer 158 with an enlarged diameter aids in securing the harness 147 within the channel 118. In some embodiments, the harness 147 may include a swivel 160 connected to either the line end 152 of the hook end 154, the latter of which is shown in FIG. 12.

Alternative embodiments of the body 102 are illustrated in FIGS. 13, 14, and 15. In a number of embodiments, the lure body 102 may include any number of the following: an anterior dorsal fin 162, a posterior dorsal fin 164, a caudal fin 166, a pair of pectoral fins 168, a pair of pelvic fins 170, and an anal fin 172. Like a living fish, the fins provide stability to the lure 100 as the body 102 moves through the water. As shown in FIG. 15, the caudal fin 166 may be relatively large such that the height of the fin 166 is greater than the height of the central portion 106 of the body 102.

In some of the embodiments, the body 102 may include one of more posterior channels 168, such as shown in FIGS. 4, 7, 13, and 15. The posterior channel 168 may extend dorsally and posteriorly from the ventral side 112 of the central portion 106 to the dorsal side 110 of the central portion 106.

An additional harness 120 (or 134 or 147) may be received within the posterior channel 168, such as shown in FIG. 15. The line end 128 of the harness 120 within the posterior channel 168 may be connected to the hook end 130 of the harness within the anterior channel 118, with a hook 126 attached to the hook end 130 of the harness 120 positioned within the posterior channel 168 such that the hook is positioned on the dorsal side 110 of the central portion 106.

Those skilled in the art will understand that the preceding exemplary embodiments of the present invention provide the foundation for numerous alternatives and modifications thereto. These and other modifications are also within the scope of the present invention. Accordingly, the present invention is not limited to that precisely as shown and described above but by the scope of the appended claims.

What is claimed is:

1. A fishing lure comprising:
a body having a head, a central portion, a tail, a dorsal side, and a ventral side;
the body having a centerline defined from the head to the tail and between the dorsal and ventral sides;
the body having a center of gravity located between the centerline and the dorsal side.

2. A fishing lure as claimed in claim 1 wherein the body has a width defined between a right side and a left side thereof;
the width of the body being greater between the centerline and the dorsal side than between the centerline and the ventral side.

3. A fishing lure as claimed in claim 2 wherein the body has a trapezoidal cross-sectional profile.

4. A fishing lure as claimed in claim 1 wherein the body includes a channel for receiving a harness.

5. A fishing lure as claimed in claim 4 wherein the channel extends between the head and the ventral side of the body.

6. A fishing lure as claimed in claim 5 wherein the channel extends through the body at an angle with respect to the center line;
the angle being in a range from about 30 degrees to about 60 degrees.

7. A fishing lure as claimed in claim 4 further comprising a harness received within the channel.

8. A fishing lure as claimed in claim 4 wherein the body includes a second channel extending from the head to the dorsal side of the central portion.

9. A fishing lure as claimed in claim 1 wherein the body has a right side and a left side and includes a pathway through which water is passable and extending from the head to one of the sides.

10. A fishing lure as claimed in claim 9 wherein the body includes a plurality of the pathways.

11. A fishing lure as claimed in claim 1 further comprising a harness for attaching to line.

12. A fishing lure as claimed in claim 11 wherein the body includes a channel extending from the head to the ventral side of the central portion for receiving the harness.

13. A fishing lure as claimed in claim 12 wherein the harness includes a line end and a hook end;
the line end being positioned at or near an opening of the channel in the head of the body and the hook end being positioned at or near an opening of the channel in the ventral side of the central portion of the body when the harness is received within the channel.

14. A fishing lure as claimed in claim 13 wherein the harness has a through hole extending from the line end to the hook end for receiving line.

15. A fishing lure as claimed in claim 14 wherein line is freely moveable within the through hole.

16. A fishing lure comprising:
a body having a head, a central portion, a tail, a dorsal side, and a ventral side;
the body including a channel formed therethrough from the head to the central portion at an angle in the range of about 30 degrees to about 60 degrees; and
the channel for receiving a harness.

17. A fishing lure as claimed in claim 13 further comprising a harness received within the channel.

18. A fishing lure comprising:
a body having a head, a central portion, a tail, a dorsal side, and a ventral side;
the body including a channel formed therethrough from the head to the central portion at an angle in the range of about 30 degrees to about 60 degrees; and
a harness received within the channel and having a line end, a hook end, and a through hole extending between the ends for sidably receiving line;
the line end being positioned at or near an opening of the channel in the head of the body and the hook end being positioned at or near an opening of the channel in the ventral side of the central portion of the body.

19. A fishing lure as claimed in claim 18 wherein the body has a center line defined from the head to the tail and between the dorsal and ventral sides;
the body having a center of gravity located between the centerline and the dorsal side.

20. A fishing lure as claimed in claim 18 further comprising:
a line extending through the through hole of the harness; and
a hook attached to an end of the line at or near the ventral side of the central portion.

21. A device for attaching a fishing lure to line, the fishing lure including a body with a channel, the device comprising:
a harness being receivable within the channel and having a line end, a hook end, and a through hole extending from the line end to the hook end for slidably receiving line.

22. A device as claimed in claim 21 wherein the harness is made from lead.

23. A device as claimed in claim 21 wherein the harness is substantially tubular.

24. A device as claimed in claim 21 wherein the harness is elongate.
